(19) United States
(12) Patent Application Publication
(10) Pub. No.: US 2024/0396125 A1
(43) Pub. Date: Nov. 28, 2024

(54) BATTERY PRESSURIZATION SYSTEM

(71) Applicant: Tesla, Inc., Austin, TX (US)

(72) Inventors: Luke David James Gregoris, San Francisco, CA (US); Ethan Perrin, Palo Alto, CA (US); Joseph Saginaw, Palo Alto, CA (US); Marcus Stack, Palo Alto, CA (US); Ajinkya Shirude, Palo Alto, CA (US); Westbrook Morrill, Santa Clara, CA (US); Nathaniel Hall-Snyder, San Francisco, CA (US)

(21) Appl. No.: 18/672,830

(22) Filed: May 23, 2024

Related U.S. Application Data
(60) Provisional application No. 63/469,011, filed on May 25, 2023.

(51) Int. Cl. H01M 50/141; H01M 10/42; H01M 10/48; H01M 50/249; H01M 50/333

(52) U.S. Cl. CPC H01M 50/141; H01M 10/4228; H01M 10/486; H01M 50/249; H01M 50/333; H01M 2200/20

(57) ABSTRACT

The disclosed technology is directed to a system for positively pressurizing a battery pack when the battery pack is submerged. In some embodiments, during a submersion event, a sensor detects a pressure inside the battery pack to generate a signal indicating the pressure inside the battery pack. The sensor then transmits the first signal to a pressure controller. The pressure controller adjusts the pressure inside the battery pack within a range based on the first signal to prevent ingress of liquid into the battery pack during the submersion event.

### CLAIM OF PRIORITY

This patent application claims the benefit of priority to Gregoris et al, U.S. Provisional Patent Application Ser. No. 63/469,011, entitled “BATTERY PRESSURIZATION SYSTEM,” filed on May 25, 2023, which is hereby incorporated by reference herein in its entirety.

### TECHNICAL FIELD

The present disclosure relates to systems and methods for protecting batteries against submersion. More particularly, some embodiments of the present disclosure relate to controllers and sensors capable of protecting a voltage battery pack against water ingress by positively pressurizing through gas (e.g., air).

### BACKGROUND

Electric vehicles typically require a large multiple of power, sometimes as much as a thousand times more than that of a typical consumer device, such as a mobile device. To achieve these power requirements, the battery packs of electric vehicles typically include a large, dense arrangement of individual cells. The service life and performance of the battery pack will often depend on the characteristics of the individual battery cells, the total number of individual cells that are incorporated into the battery pack, and configurations/orientations of the cells and ancillary components into modules of the battery pack. The battery pack may represent one of the most expensive and massive assemblies in the context of electric vehicle transportation and grid storage applications. As such, it may be desirable to protect a battery pack from intrusion, interference or contamination associated with external substances to maintain or extend the service life of the battery pack.

### SUMMARY

The systems, methods, and devices of this disclosure each have several innovative embodiments, no single one of which is solely responsible for all of the desirable attributes disclosed herein. Details of one or more implementations of the subject matter described in this specification are set forth in the accompanying drawings and the description below.

Some examples of the present disclosure relate to a battery pressurization system designed for electric vehicles, particularly for off-road vehicles such as a truck, which may be subjected to submersion events or require long water crossing durations. Example systems aim to protect the battery pack from water ingress and to provide a means for checking the integrity of the battery pack sealing over the vehicle's lifetime.

Some examples utilize a pressure sensor and a pressure controller to maintain the pressure inside a battery pack at a level that prevents water ingress during submersion events. Some example systems are capable of detecting ambient pressure and adjusting the internal pressure of the battery pack to be approximately 0.85 psi or about 6 kPa above the detected ambient pressure. Other pressure ranges are possible for example as described below. This pressurization ensures that air will flow out of any leaks, rather than water flowing into the leaks, effectively preventing water ingress.

Some example battery pressurization systems include which is normally closed and requires energization to open. Example valves are designed to have a double seal to ensure a robust closure. Example systems also include hoses that connect the valve to various volumes within the battery pack, including the ancillary and the enclosure volumes. In some examples, an ancillary volume contains electronics, busbars, and other components, while an enclosure volume houses battery cells.

Some example systems are further equipped with pressure release valves that are spring-loaded to prevent over-pressurization of the battery pack. These valves open to release air if the pressure exceeds a certain threshold, seeking to ensure the safety of the system.

Some example systems operate within a pressure range within the battery pack of approximately 80 kPa to 115 kPa and are designed to account for known leak rates in a battery pack and can adjust the pressure accordingly. Example systems can also perform a pack check at any point in the vehicle's life to determine the sealing integrity of the battery pack. If a leak is detected, the system can flag an error for the user, indicating that service may be required.

Some example systems are designed to function effectively in various environmental conditions, including changes in altitude and temperature, or pressure changes due to heat generation during battery charging. Some example systems are capable of handling salt water and freshwater immersion.

Some examples systems include a feature for detecting thermal changes within the battery pack. By monitoring pressure changes associated with heat generation, during battery charging for example, example systems can detect a degree of breach in the battery pack's sealing. Example features utilize existing hardware and software of the vehicle and seek to provide an additional safeguard for ensuring the integrity of the battery pack over the vehicle's lifetime.

Example battery pressurization systems described herein seek to provide a robust solution for protecting battery packs in electric vehicles, particularly those designed for off-road use. The system's ability to prevent water ingress and monitor the sealing integrity of the battery pack seeks to enhance the safety and reliability of the vehicle, ensuring user confidence in various operating conditions.

An aspect is thus directed to a battery ingress prevention system for a vehicle. The battery ingress prevention system includes at least a pressure sensor and a pressure controller. The battery ingress prevention system is capable of adjusting a pressure within a battery pack of a vehicle within a range through positively pressurizing the battery pack using air from an air source.

In some aspects, the techniques described herein relate to a system for sealing a battery pack during a submersion event associated with the battery pack, the system including: a first sensor configured to: detect a pressure inside the battery pack to generate a first signal indicating the pressure inside the battery pack; and transmit the first signal to a pressure controller; the pressure controller configured to adjust the pressure inside the battery pack within a range based on the first signal to prevent ingress of liquid into the battery pack during the submersion event.

In some aspects, the techniques described herein relate to a system, wherein the pressure controller causes a valve connected to a pressure source to open to adjust the pressure inside the battery pack toward an upper bound of the range.

In some aspects, the techniques described herein relate to a system, wherein the pressure controller causes the valve connected to the pressure source to close when the first signal indicates pressure inside the battery pack reaches the upper bound of the range.

In some aspects, the techniques described herein relate to a system, wherein the pressure controller causes the valve connected to the pressure source to open when the first signal indicates pressure inside the battery pack reaches a lower bound of the range.

In some aspects, the techniques described herein relate to a system, wherein the pressure controller causes the valve open when a pressure inside a battery pack is below a predetermined range, and wherein the pressure controller causes the valve close when the pressure inside the battery pack is above the predetermined range.

In some aspects, the techniques described herein relate to a system, wherein the pressure source is a standalone reservoir or a part of an air suspension system of a vehicle.

In some aspects, the techniques described herein relate to a system, further including a second sensor configured to detect the submersion event associated with the battery pack.

In some aspects, the techniques described herein relate to a system, wherein responsive to detecting the submersion event also with the battery pack, the second sensor generates a second signal to enable the pressure controller to adjust the pressure inside the battery pack within the range.

In some aspects, the techniques described herein relate to all embodiments described and discussed above.

### BRIEF DESCRIPTION OF THE DRAWINGS

Throughout the drawings, reference numbers are re-used to indicate correspondence between referenced elements. The drawings are provided to illustrate examples of the subject matter described herein and not to limit the scope thereof.

FIG. 1 depicts an example representation of an electric vehicle 100 in which embodiments of the present disclosure can be implemented.

FIGS. 2A-2C depict various perspective views of at least a portion of the battery ingress prevention system shown in FIG. 1 along with other components of an electric vehicle in accordance with some embodiments of the present disclosure

FIG. 3 illustrates block diagrams representing at least some of the components of the system shown in FIG. 1 in accordance with some embodiments of the present disclosure.

FIG. 4 depicts an illustrative process for protecting a battery pack by positively pressurizing the battery pack during a submersion event in accordance with some embodiments of the present disclosure.

### DETAILED DESCRIPTION

Generally described, one or more aspects of the present disclosure correspond to systems and methods that protect battery packs against submersion, water ingress or liquid ingress. More specifically, some embodiments of the present disclosure disclose mechanisms and assemblies that seal any voltage battery packs (e.g., high voltage, low voltage or any voltage battery packs that have cells within) against liquid (e.g., water) ingress through positively pressurizing the battery packs. In some embodiments, positively pressurizing the battery pack may result in the pressure inside a battery pack to be higher than an ambient pressure (e.g., pressure outside the battery pack) by a predetermined value (e.g., 0.8 psi) or range. Additionally, the predetermined value or range may be adjustable according to the degree of submersion. For example, the predetermined value or range may increase when the battery pack is submerged under water to a greater depth.

In some embodiments, while a battery pack is under submersion, a sensor may track pressure within the battery pack to regulate pressure level within the battery pack above a reference pressure level. In some embodiments, a gas (e.g., air) may flow from a gas reservoir into the battery pack. In some embodiments, the system controls the amount of flow by operating a valve connected between the gas reservoir and the battery pack. In some embodiments, the gas flows through an orifice of the valve. Further, the system can adjust a diameter of the orifice or one or more breather valves of the battery in pack to control a rate of gas flow from the reservoir to the battery pack such that the battery pack will not be over-pressurized.

In some embodiments, a vehicle sensor suite may detect if the battery pack or a vehicle to which the battery pack is attached is under submersion and may generate a control signal responsive to detecting the battery pack is under submersion. The control signal may cause a pressure controller to activate a water rejection mode during which a pressure sensor may measure pressure within the battery pack to trigger the positive pressurization of the battery pack. In some embodiments, the vehicle sensor suite generates the control signal when certain criteria (e.g., over 30% of the battery pack height is submerged) is met such that the vehicle sensor suite is not overly sensitive in detecting events of submersion. Advantageously, this can prevent a battery pack assembly from entering the water rejection mode in situations where pressurizing the battery pack is not needed to protect the battery pack from ingress of liquid. Alternatively, instead of triggered by the control signal generated by the vehicle sensor suite, the activation of the water rejection mode can be triggered by drivers/passengers of the electric vehicles.

Battery packs for electric vehicles or any (e.g., high voltage, low voltage or any voltage) voltage battery packs can be sealed using adhesives, molded seals, foam seals, or the like. One common way of sealing battery packs is by adding temperature curative adhesive (RTV) around the covers of the battery pack. Another sealing approach adds foam or molded seal around enclosures of battery packs. However, these techniques might not yield desirable level of sealing (e.g., approaching 100% leak-proof), such as when air pressure outside the battery pack is substantially higher than air pressure inside the battery pack. Additionally, surface imperfections and manufacturing limitation may also prevent desirable level of sealing. Although fasteners, stamped reinforcement or welding techniques may be further combined to increase clamp forces to improve sealing, they incur extra cost of manufacturing. Further, battery packs of electric vehicles are generally leak-tested toward the end of production cycle such that there may be no monitoring of sealing performance over the service life of the battery pack.

Additionally, breathers or breather valves are generally deployed to regulate pressure within a battery pack by allowing air flow or exchange (e.g., venting from inside the battery packs to ambient environment) that may be beneficial for the battery packs. As such, it may be desirable to develop sealing techniques that can work with breather valves to provide an adequate level of sealing under the existence of pressure drop resulted from breather valves.

Methods and systems for protecting battery packs of electric vehicles through positive pressurization are disclosed in accordance with some embodiments of the present disclosure. Specifically, when a submersion event (e.g., when a battery pack is partially or fully submerged under water) is detected, a valve connected to a pressure source may open to inject air from the pressure source into the battery pack. The valve may close again when air pressure inside the battery pack is above ambient environment by a certain range. As such, air pressure inside the battery pack can be above a lower bound to prevent ingress of liquid and below an upper bound to prevent over-pressurization. In some embodiments, the valve is normally closed to prevent positively pressurizing the battery pack when the battery pack is not partially nor completely submerged.

In some embodiments, the battery pack assembly may include a vehicle sensor suite (e.g., a pressure sensor) for detecting the submersion event. In response to detecting the submersion event, the vehicle sensor suite can generate a control signal and transmits the control signal to a pressure controller. Responsive to receiving the control signal, the pressure controller may enter a water rejection mode to trigger a positive pressurization of the battery pack. In some embodiments, the vehicle sensor suite may include a ride height sensor, a vision sensor, or a tire pressure sensor. Additionally or optionally, part or all of the vehicle sensor suite may be mounted on a printed circuit board (PCB) or integrated as part of an electronic control unit (ECU) associated with the electric vehicles.

More specifically, under the water rejection mode, a pressure sensor inside the battery pack may continually measure pressure within the battery pack and provide measured pressure values to the pressure controller such that the pressure controller can cause the valve connected to the pressure source to regulate the air pressure within the battery pack to stay within a predetermined range by opening or closing. In some embodiments, the pressure sensor may measure pressure inside the battery pack before the valve opens or air starts to flow from the pressure source into the battery pack. For example, the pressure sensor may measure a reference pressure value within the battery pack when the battery pack is submerged but before air starts to flow from the pressure source into the battery pack.

The pressure controller may cause the valve to open to allow air flow from the pressure source into the battery pack until the pressure sensor measures and transmits to the pressure controller a current pressure value within the battery pack that reaches an upper bound. In some embodiments, the upper bound is 0.8 psi, 0.85 psi, or 1 psi above the reference pressure value. As such, positive pressurization may stop when pressure within the battery pack is above pressure outside the battery pack by 0.8 psi, 0.85 psi or 1 psi. Advantageously, this prevents the battery pack from being over-pressurized.

In some embodiments, after the system stops air flow from the pressure source into the battery pack, the pressure sensor may continue measuring the pressure within the battery pack and transmit a current pressure value within the battery pack to the pressure controller. When the current pressure value drops below a lower bound, the pressure controller may again activate the valve to positively pressurize the battery pack. In some embodiments, the lower bound may be 0.65 psi or 0.7 psi above the reference pressure value. As such, positive pressurization may start again to ensure that pressure within the battery pack is above the pressure outside the battery pack by 0.65 psi or 0.7 psi.

In this way, the battery pack is sufficiently pressurized to prevent ingress of water. When a submersion event ends, the battery pack assembly exits the water rejection mode and the valve will close to ensure air does not flow from the pressure source to inside the battery pack. With the battery pack not hermetically sealed, pressure within the battery pack may gradually decay back to ambient pressure outside the battery pack. In some embodiments, the battery pack associated with some embodiments of the present disclosure can be implemented to meet certain standards, such as IP ratings IP65, IP67, or ratings beyond IP67.

In some embodiments, the pressure within the pressure source may be maintained around 20 Bar. Air within the pressure source may flow into the battery pack through a valve and a hose that connects the pressure source and the battery pack. In some embodiments, an orifice that allows air flowing from the pressure source to the battery pack is designed to control a rate of air flow into the battery pack. For example, the air flow rate may be between 0.01 psi to 0.02 psi per second. Notably, the controlled air flow rate helps prevent over-pressurization of the battery pack. In some embodiments, the valve may be a solenoid valve that can be driven to open or close by a solenoid driver. In some embodiments, in addition to being triggered to open by a pressure controller, the valve can open in response to user-triggered operation. For example, a user interface associated with a display (e.g., a center display) or other component of an electric vehicle may present user interface elements that allow the user to manually turn on the valve to initiate positive pressurization of the battery pack.

In some embodiments, some or all of the vehicle sensor suite, pressure controller, pressure sensor, and valve may be integrated structurally with a battery pack of the electric vehicle or with a high voltage battery pack. As such, a unified battery pack may include components for positively pressurizing the battery pack. In some embodiments, existing components of the electric vehicle can be utilized for positively pressurizing the battery pack. For example, instead of using a separate pressure source for positively pressurizing the battery pack, the battery pack assembly may reuse or tap the reservoir being used for the air suspension system of the electric vehicle. As such, additional cost associated with the deployment of the battery pack assembly for positively pressurizing the battery pack in the event of submersion or when there is a need to stop ingress of external liquids into the battery pack can be reduced.

Although the various aspects will be described in accordance with illustrative embodiments and combination of features, one skilled in the relevant art will appreciate that the examples and combination of features are illustrative in nature and should not be construed as limiting. More specifically, aspects of the present application may be applicable with various types of batteries, battery packs, battery pack enclosures under different contexts, such as when attached to a bottom, rear, front, or a surface of a vehicle, attached to fixed structures (e.g., buildings), or attached to different types of transportation tools, including but not limited to aircraft, spacecraft, trucks, vessels, maritime, ferry and vans.

Still further, although specific architectures of battery pack assemblies or battery ingress prevention systems (e.g., the pressure sensor, the vehicle sensor suite, the pressure controller and the valve) for positively pressurizing battery packs will be described, such illustrative battery pack assemblies design or architecture should not be construed as limiting. Accordingly, one skilled in the relevant art will appreciate that the aspects of the present application are not necessarily limited to application to any particular types of battery pack assemblies, battery ingress prevention systems, battery pack infrastructure, battery pack enclosures, or unitary battery packs.

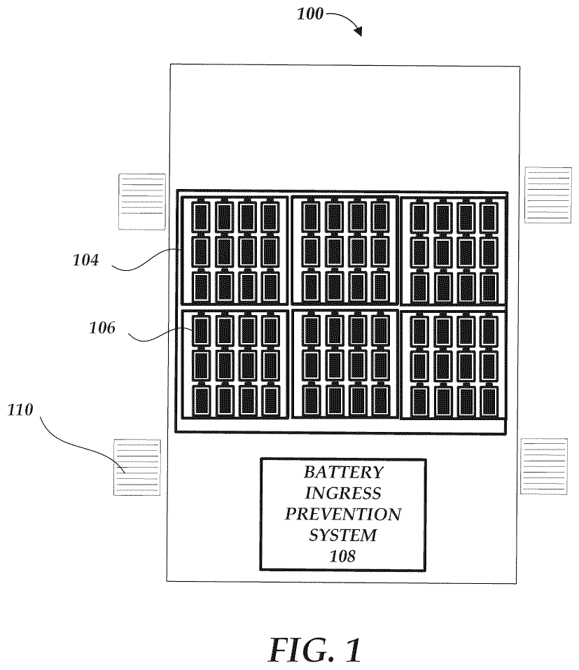

FIG. 1 depicts an example electric vehicle 100 in which embodiments of the present disclosure can be implemented. As shown in FIG. 1, the electric vehicle 100 has one or more battery packs 104, a battery ingress prevention system 108 and a plurality of wheels 110. In some embodiments, the battery packs 104 can include a plurality of battery cells 106. The configuration of battery packs 104 and battery cell 106 can be determined based on specific applications. The battery ingress prevention system 108 can be configured to positively pressurizing the battery packs 104. For example, the battery ingress prevention system 108 can monitor or track the pressure within the battery packs 104 and maintain the pressure within the battery packs 104 above the pressure outside the battery packs 104 in the event that the battery packs 104 are submerged under water.

Although an automobile is shown in FIG. 1 as the example electric vehicle 100, the vehicle 100 can be different types of transportation tools, including but not limited to aircraft, spacecraft, trucks, vessels, maritime, ferry and vans that utilize high voltage battery packs to provide energy to the transportation tools. Additionally, the battery packs 104 and the battery ingress prevention system 108 may be deployed in less movable or non-movable structures (e.g., buildings).

In some embodiments, the battery ingress prevention system 108 may include a pressure sensor, a pressure source, and a pressure controller for tracking and regulating pressure within the battery packs 104. It should be noted that, although illustrated separately, some or all of the battery ingress prevention system 108 can be integrated with the battery packs 104 or re-used from other existing components (not shown in FIG. 1) of the electric vehicle 100. For example, the pressure source of the battery ingress prevention system 108 may be the same as the pressure source for an air suspension system of the electric vehicle 100. Alternatively, in other embodiments, the battery ingress prevention system 108 may have its own components separate from other components of the electric vehicle 100.

As will be discussed below, in some embodiments, the battery ingress prevention system 108 may seal the battery packs 104 against liquid (e.g., water) ingress during a submersion event through positively pressurizing the battery packs 104. In some embodiments, positively pressurizing the battery packs 104 may result in the pressure inside the battery packs 104 to be higher than an ambient pressure (e.g., pressure outside the battery packs 104) by a predetermined value or range. In some embodiments, the predetermined value or range may be adjustable according to the degree of submersion. For example, the battery ingress prevention system 108 may positively pressurize the battery packs 104 to a higher pressure if the battery packs 104 are submerged in water to a greater depth. In some embodiments, pressure within the battery pack 104 adjusted by the battery ingress prevention system 108 may prevent water ingress into the battery packs 104 when a height of water outside the battery packs 104 is around 700 millimeters to 900 millimeters.

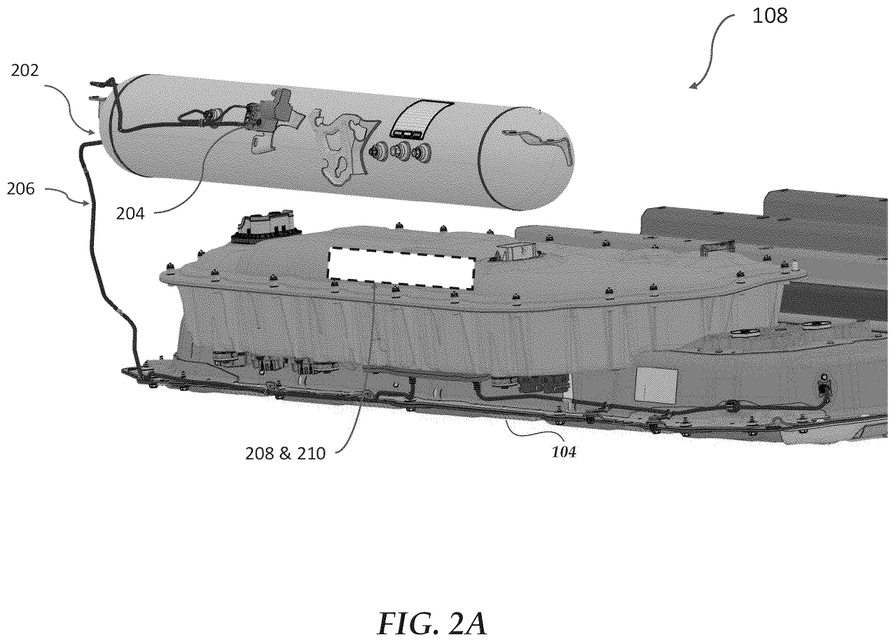

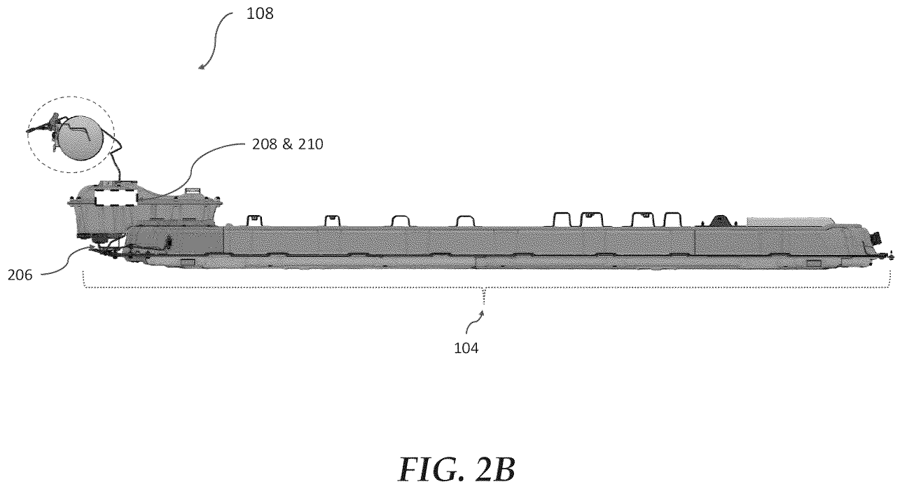

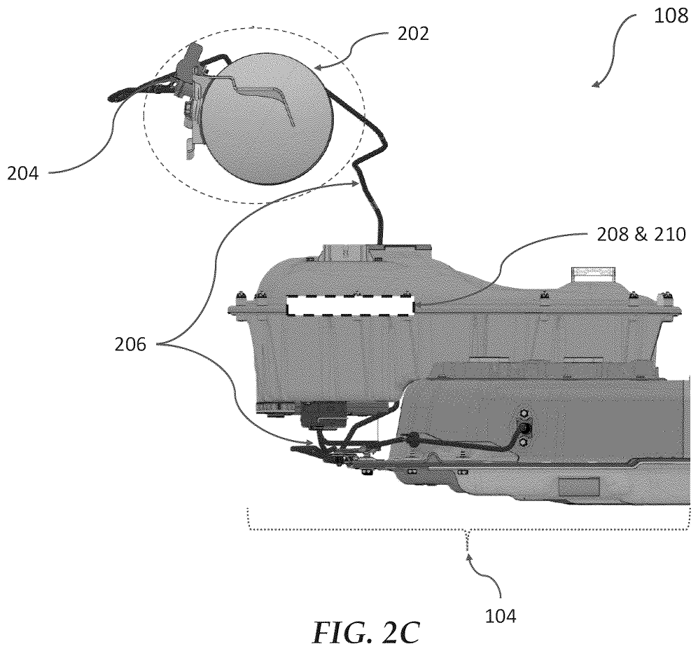

FIG. 2A depicts a perspective view of at least a portion of the battery ingress prevention system 108 of FIG. 1 along with other components of the electric vehicle 100 in accordance with some embodiments of the present disclosure. As shown in FIG. 2A, the battery ingress prevention system 108 includes various components, such as a pressure source 202, a valve 204, a hose 206, a pressure sensor 208, and a pressure controller 210. Also shown in FIG. 2A is the battery pack 104 of the electric vehicle 100. Although not readily observed from FIG. 2A, when the valve 204 opens, air within the pressure source 202 may flow into the battery pack 104 through the hose 206. In some examples, the pressure sensor 208 and the pressure controller 210 are mounted on or in connection with an ancillary battery enclosure, as shown. The ancillary enclosure may contain electronics, busbars, and other components, while the adjacent enclosure volume (or main battery enclosure) houses battery cells of the battery packs 104.

In some embodiments, the pressure sensor 208 may be integrated as a part of a component or controller associated with the electric vehicle 100. Additionally, the pressure sensor 208 may be deployed and configured to sense a pressure within the battery pack 104. In some embodiments, when the battery pack 104 is under submersion, the pressure sensor 208 may track pressure within the battery pack 104 for regulating pressure level within the battery pack 104 above a reference pressure level. When the battery pack 104 is under submersion, the pressure controller 210 may cause the valve 204 to open to let air flow from the pressure source 202 into the battery pack 104. While the valve 204 opens, the pressure sensor 208 may keep measuring pressure within the battery pack 104 to provide a measured pressure value to the pressure controller 210. When the pressure value reaches a predetermined value (e.g., an upper bound of pressure), the pressure controller 210 may cause the valve 204 to close such that air stops flowing from the pressure source 202 into the battery pack 104.

In some embodiments, after the valve 204 closes to stop allowing air to flow from the pressure source 202 into the battery pack 104, the pressure sensor 208 may continue measuring pressure within the battery pack 104 and provides measured pressure values within the battery pack 104 to the pressure controller 210. If the measured pressure value within the battery pack 104 drops below a predetermined value (e.g., a lower bound of pressure) and the battery pack 104 is under submersion, the pressure controller 210 may turn on the valve 204 to positively pressurize the battery pack 104.

In some embodiments, the battery ingress prevention system 108 may include a vehicle sensor suite (although not shown in FIG. 2A) for detecting if the battery pack 104 is under submersion. In some embodiments, the vehicle sensor suite may be or include a ride height sensor, a vision sensor, or a tire pressure sensor. In response to detecting the battery pack 104 is partially or fully submerged, the vehicle sensor suite may generate a control signal and transmits the control signal to the pressure controller 210. Responsive to receiving the control signal, the pressure controller 210 may enter a water rejection mode to trigger a positive pressurization of the battery pack 104. During the positive pressurization, the pressure within the battery pack 104 may be regulated by the pressure controller 210 through controlling the valve 204 based on measured pressure within the battery pack 104 provided by the pressure sensor 208. In some embodiments, the pressure within the battery pack 104 may be regulated by the pressure controller 210 to be above a pressure outside the battery pack 104 from 0.6 psi to 1.0 psi.

FIGS. 2B-2C illustrate various perspective views of at least a portion of the battery ingress prevention system 108 of FIG. 1 depicted in FIG. 2A. Shown in FIGS. 2B-2C include the pressure source 202, the valve 204, the hose 206, and the pressure sensor 208, and the pressure controller 210. Also shown in FIGS. 2B-2C is the battery pack 104 of the electric vehicle 100. As indicated in FIGS. 2B-2C, when the valve 204 opens based on measurements associated with the pressure sensor 208, air within the pressure source 202 may flow into the battery pack 104 through the hose 206 to prevent liquid ingress into the battery pack 104.

In some embodiments, the pressure source 202 may be any air source existing in the electric vehicle 100, such as an air pump, compressor, a pressure vessel, or a part of an air suspension system that may be deployed in the electric vehicle 100. Advantageously, by re-using existing components associated with the electric vehicle 100, cost associated with the battery ingress prevention system 108 may be controlled. In other embodiments, the pressure source 202 may be dedicated for positively pressurizing the battery pack 104. As such, design or control of the battery ingress prevention system 108 may be simplified.

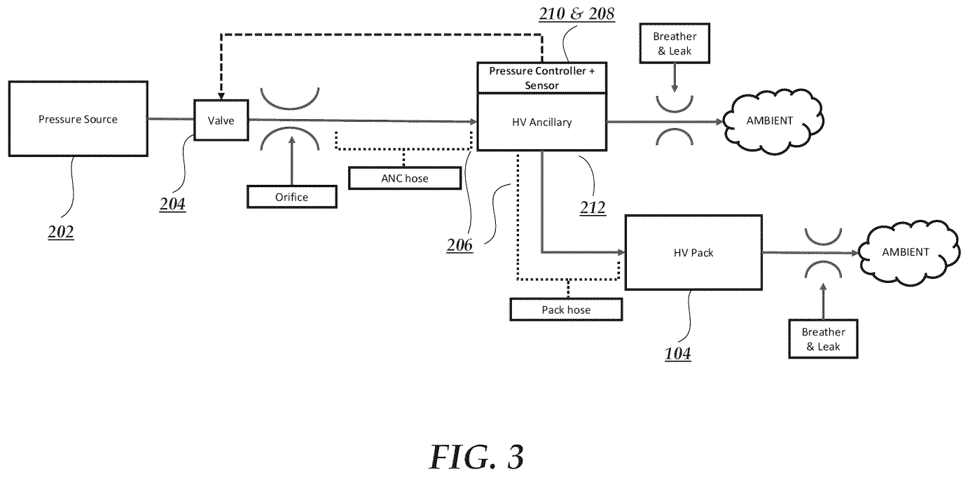

FIG. 3 illustrates block diagrams representative of at least some of the components of the battery ingress prevention system 108 of FIG. 1 in accordance with some embodiments of the present disclosure. As illustrated in FIG. 3, the battery ingress prevention system 108 may include: the pressure sensor 208 within the HV (high voltage) Ancillary 212, the pressure controller 210 and a vehicle sensor suite (not shown in FIG. 3). Additionally, the battery ingress prevention system 108 may further include the valve 204 and the hose 206. In operation, air may flow from the pressure source 202 through the valve 204 and the hose 206 to enter into the battery pack 104 such that the battery pack 104 may be positively pressurized when the battery pack 104 is partially or fully submerged by liquids. The pressure source 202 may be a standalone reservoir that stores air or may be integrated with other parts (e.g., air suspension system or pump or the like) of the electric vehicle 100.

As illustrated in FIG. 3, in some embodiments, the pressure controller 210 and the pressure sensor 208 can be both integrated within the HV Ancillary 212. In some embodiments, the HV Ancillary 212 may include other components, such as high voltage components including, but not limited to, power conversion system, HV controller, busbars or the like.

The vehicle sensor suite may detect if the battery pack 104 is submerged. Some or all of the vehicle sensor suite may be integrated as a part of the trailer electronic control unit (ECU) of the electric vehicle 100. The vehicle sensor suite may include a vision sensor, a ride height sensor, a tire pressure sensor or the like to send a control signal to the pressure controller 210 to indicate that the battery pack 104 is submerged.

Responsive to receiving the signal indicating that the battery pack 104 is submerged, the pressure controller 210 may enter a water rejection mode to initiate positive pressurization of the battery pack 104. During the water rejection mode, the pressure controller 210 may control the position of the valve 204 based on pressure information provided by the pressure sensor 208. Specifically, the pressure sensor 208 may track and measure pressure within the battery pack 104 and provide measured pressure values to the pressure controller 210. Based at least in part on the measured pressure values, the pressure controller 210 can cause the valve 204 connected to the pressure source 202 to open or close so as to regulate the air pressure within the battery pack 104 to be within a predetermined range which prevents ingress of water or other liquids.

In some embodiments, the pressure sensor 208 may measure pressure inside the battery pack 104 before the valve 204 opens or air starts to flow from the pressure source 202 into the battery pack 104. For example, the pressure sensor 208 may measure a reference pressure value within the battery pack 104 when the battery pack 104 is submerged but before air starts to flow from the pressure source 202 into the battery pack 104.

Based on the pressure values measured by the pressure sensor 208, the pressure controller 210 may cause the valve to open to allow air flow from the pressure source 202 into the battery pack 104 until the pressure within the battery pack 104 reaches an upper bound (e.g., 0.8 psi, 0.85 psi, or 1 psi above the reference pressure value). In some embodiments, after the valve 204 closes to stop air flow from the pressure source 202 into the battery pack 104, the pressure sensor 208 may continue measuring pressure within the battery pack 104 and provide pressure information associated with the battery pack 104 to the pressure controller 210. If the pressure within the battery pack 104 drops below a lower bound (e.g., 0.65 psi or 0.7 psi above the reference pressure value) and the battery pack 104 is still under submersion based on information provided by the vehicle sensor suite, the pressure controller 210 may cause the valve 204 to turn on to positively pressurizing the battery pack 104 toward the upper bound.

If the vehicle sensor suite detects that the battery pack 104 is not under submersion, the pressure controller 210 may exit the water rejection mode and cause the valve 204 to close such that air will not flow from the pressure source 202 into the battery pack 104. In some embodiments, after the battery ingress prevention system 108 exits the water rejection mode, pressure within the battery pack 104 may gradually decrease to ambient pressure outside the battery pack 104 because the battery pack 104 is not 100% sealed against air or water leakage.

As discussed above, when the valve 204 opens based on measurements from the pressure sensor 208, air may flow from the pressure source 202 through the hose 206 to enter into the battery pack 104 such that the battery pack 104 may be positively pressurized when the battery pack 104 is partially or fully submerged by liquids.

In some embodiments, pressure within the pressure source 202 may be 21 Bar under temperature of 0° C. with air volume being 17.4 liter (L) stored in the pressure source 202. In other embodiments, the pressure and air volume stored in the pressure source 202 can be different from 21 Bar and 17.4 L. In some embodiments, the hose 206 may be around 2267 millimeter (mm) between the valve 204 and the pressure sensor 208, and around 747 mm between the pressure sensor 208 and the battery pack 104. In other embodiments, the hose 206 can be shorter or longer than what is described above. In some embodiments, a diameter of the orifice that allows air from the pressure source to flow into the battery pack 104 may be 0.45 mm. In other embodiments, the diameter of the orifice can be greater than or smaller than 0.45 mm. In still other embodiments, the diameter of the orifice may be adjusted to control rate of air flow from the pressure source to the battery pack such that the battery pack will not be over-pressurized.

In some embodiments, when pressure measured by the pressure sensor 208 is below 0.75 psi, the pressure controller 210 may cause the valve 204 to open to allow air flow from the pressure source 202 through the hose 206 into the battery pack 104 such that the pressure within the battery pack 104 may increase to prevent ingress of liquids. When pressure measured by the pressure sensor 208 is above 0.85 psi, the pressure controller 210 may cause the valve 204 to close to stop or decrease air flow from the pressure source 202 through the hose 206 into the battery pack 104 such that pressure within the battery pack 104 may not keep increasing to prevent over-pressurization of the battery pack 104. In other embodiments, the pressure measured by the pressure sensor 208 upon which the pressure controller may cause the valve 204 to open or close may be different from 0.75 psi and/or 0.85 psi. In some embodiments, after the valve 204 closes, pressure within the battery pack 104 may slowly decrease to ambient pressure as the air exits the battery pack 104 through a leak orifice of the battery pack 104.

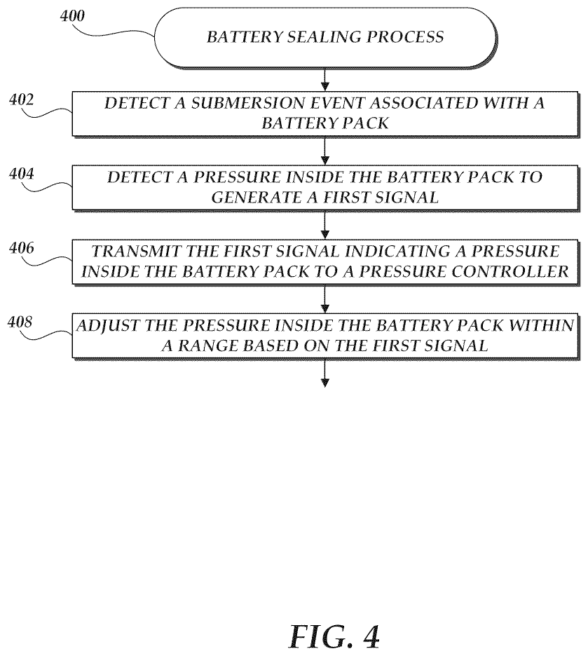

With reference to FIG. 4, an illustrative process 400 for sealing a battery pack through positively pressurizing the battery pack during a submersion event will be described. The process 400 may be implemented by the battery ingress prevention system 108 as described in FIGS. 1-3. To simplify discussion and not to limit the present disclosure, the process 400 will be described with respect to particular elements or systems. Although the described flow diagram below can show operations as a sequential process, some of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

The process begins at 402, where the vehicle sensor suite detects a submersion event or underside abuse leaks associated with the battery pack 104. Alternatively, a user may activate or trigger the submersion event by interacting with a user interface to positively pressurizing the battery pack. As such, the submersion event can be user-triggered or user-defined so that a user may positively pressurizing the battery pack 104 when the user sees fit or a need to do so. As discussed above, the vehicle sensor suite may include a ride height sensor, a vision sensor, or a tire pressure sensor. Optionally, some or all of the vehicle sensor suite may be integrated as a part of an electronic control unit (ECU) of an electric vehicle and may be mounted on a printed circuit board (PCB). In some embodiments, the vehicle sensor suite detects the submersion event after the battery pack is partially or completely submerged for a period of time (e.g., sixty seconds). As such, the battery ingress prevention system 108 may be prevented from positively pressurizing the battery pack 104 too frequently. In some embodiments, responsive to the vehicle sensor suite detects the submersion event, the battery ingress prevention system 108 may enter into a water rejection mode, during which air inside a pressure source 202 may flow into the battery pack 104. When the battery ingress prevention system 108 is not in the water rejection mode, air may not flow from the pressure source 202 into the battery pack 104.

At block 404, a pressure sensor 208 detects a pressure inside the battery pack 104 to generate a first signal. The first signal may indicate the pressure inside the battery pack 104.

At block 406, the pressure sensor 208 transmits the first signal indicating the pressure inside the battery pack 104 to the pressure controller 210.

At block 408, the pressure controller 210 adjusts pressure inside the battery pack 104 within a range based on the first signal. In some embodiments, the range may be 0.65 psi to 0.85 psi above pressure outside the battery pack 104.

### EXAMPLES

Thus, some embodiments may include one or more of the following examples.

Example 1. A system for protecting a battery pack during a submersion event associated with the battery pack, the system comprising: a first sensor configured to: detect a pressure inside the battery pack to generate a first signal indicating the pressure inside the battery pack; and transmit the first signal to a pressure controller; the pressure controller configured to adjust the pressure inside the battery pack within a range based on the first signal to prevent ingress of liquid into the battery pack during the submersion event.

Example 2. The system of example 1, wherein the pressure controller causes a valve connected to a pressure source to adjust the pressure inside the battery pack toward an upper bound of the range.

Example 3. The system of example 2, wherein the pressure controller causes the valve connected to the pressure source to close when the first signal indicates pressure inside the battery pack reaches the upper bound of the range.

Example 4. The system of example 2 or 3, wherein the upper bound is in a pressure range of 0.8 to 1 psi above a reference pressure value.

Example 5. The system of any one of examples 2-4, wherein the pressure controller causes the valve connected to the pressure source to open when the first signal indicates pressure inside the battery pack reaches a lower bound of the range.

Example 6. The system of example 5, wherein the lower bound is in a pressure range of 0.65 to 0.7 psi above the reference pressure value.

Example 7. The system of example 2, wherein the pressure source is a standalone reservoir or a part of an air suspension system of a vehicle.

Example 8. The system of any one of examples 1-7, further comprising a second sensor configured to detect the submersion event associated with the battery pack.

Example 9. The system of example 8, wherein responsive to detecting the submersion event associated with the battery pack, the second sensor generates a second signal to enable the pressure controller to adjust the pressure inside the battery pack within the range.

Example 10. The system of any one of examples 1-9, wherein adjusting the pressure inside the battery pack includes positively pressurizing the battery pack to result in a pressure inside the battery pack to be higher than an ambient pressure by a predetermined value or range.

Example 11. The system of example 10, wherein the predetermined value or range is adjustable according to a degree of submersion.

Example 12. The system of any one of examples 1-11, wherein the pressure controller is further configured to adjust the pressure inside the battery pack based on a detected ambient pressure, such that the pressure inside the battery pack is maintained at a predetermined value above the detected ambient pressure.

Example 13. The system of any one of examples 1-12, further comprising a valve that is normally closed and requires energization to open.

Example 14. The system of example 13, wherein the valve is configured to provide a double seal when closed.

Example 15. The system of example 1, further comprising pressure release valves.

Example 16. The system of example 15, wherein the pressure release valves are spring-loaded to prevent over-pressurization of the battery pack by releasing air when the pressure inside the battery pack exceeds a predetermined pressure threshold.

Example 17. The system of any one of examples 1-16, wherein the system is configured to perform a pack check to determine a sealing integrity of the battery pack and to flag an error if a leak is detected.

Example 18. The system of example 2, wherein the system includes hoses that connect the valve to an ancillary volume and an enclosure volume within the battery pack.

Example 19. The system of any one of examples 1-18, wherein the system is configured to operate within a pressure range inside the battery pack of approximately 80 kPa to 115 kPa.

Example 20. The system of any one of examples 1-19, wherein the system is configured to adjust the pressure inside the battery pack in response to environmental conditions including changes in altitude and temperature.

Example 21. The system of any one of examples 1-20, further comprising a feature for detecting thermal changes within the battery pack to determine a degree of breach a sealing of the battery pack.

Example 22. The system of example 21, wherein the feature for detecting thermal changes utilizes pressure changes associated with heat generation during charging of the battery pack.

Example 23. The system of any one of examples 1-22, further comprising a user interface element allowing a user to manually initiate positive pressurization of the battery pack.

It should be noted that the description and the figures above merely illustrate the principles of the present subject matter along with examples described herein and should not be construed as a limitation to the present subject matter. It is thus understood that various arrangements may be devised that although not explicitly described or shown herein, embody the principles of the present subject matter. Moreover, all statements herein reciting principles, aspects, and implementations of the present subject matter, as well as specific examples thereof, are intended to encompass equivalents thereof.

It is to be understood that not necessarily all objects or advantages may be achieved in accordance with any particular example described herein. Thus, for example, those skilled in the art will recognize that some examples may be operated in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the example, some acts, events, or functions of any of the algorithms described herein can be performed in a different sequence, can be added, merged, or left out altogether (for example, not all described acts or events are necessary for the practice of the algorithms). Moreover, in some examples, acts or events can be performed concurrently, for example, through multi-threaded processing, interrupt processing, or multiple processors or processor cores, or on other parallel architectures, rather than sequentially. In addition, different tasks or processes can be performed by different machines and/or computing systems that can function together.

The various illustrative logical blocks and modules described in connection with the examples disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combination of the same, or the like. A processor can include electrical circuitry to process computer-executable instructions. In some examples, a processor includes an FPGA or other programmable device that performs logic operations without processing computer-executable instructions. A processor can also be implemented as a combination of computing devices, for example, a combination of a DSP and a microprocessor, a plurality of microprocessors, microprocessors in conjunction with a DSP core, or any other such configuration. Although described herein primarily with respect to digital technology, a processor may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

The processes described herein or illustrated in the figures of the present disclosure may begin in response to an event, such as on a predetermined or dynamically determined schedule, on demand when initiated by a user or system administrator, or in response to some other event. When such processes are initiated, a set of executable program instructions stored on one or more non-transitory computer-readable media (e.g., hard drive, flash memory, removable media, etc.) may be loaded into memory (e.g., RAM) of a server or other computing device. The executable instructions may then be executed by a hardware based computer processor of the computing device. In some embodiments, such processes or portions thereof may be implemented on multiple computing devices and/or multiple processors, serially or in parallel.

Conditional language such as, among others, “can,” “could,” “might” or “may,” unless specifically stated otherwise, are otherwise understood within the context as used in general to convey that some examples include, while other examples do not include, some features, elements and/or steps. Thus, such conditional language is not generally intended to imply that features, elements and/or steps are in any way for examples or that examples necessarily include logic for deciding, with or without user input or prompting, whether these features, elements and/or steps are included or are to be performed in any particular example.

Disjunctive language such as the phrase “at least one of X, Y, or Z,” unless specifically stated otherwise, is otherwise understood with the context as used in general to present that an item, term, etc., may be either X, Y, or Z, or any combination thereof (for example, X, Y, and/or Z). Thus, such disjunctive language is not generally intended to, and should not, imply that some examples require at least one of X, at least one of Y, or at least one of Z to each be present.

Any process descriptions, elements or blocks in the flow diagrams described herein and/or depicted in the attached figures should be understood as potentially representing modules, segments, or portions of code which include executable instructions for implementing specific logical functions or elements in the process. Alternate examples are included within the scope of the examples described herein in which elements or functions may be deleted, executed out of order from that shown, or discussed, including substantially concurrently or in reverse order, depending on the functionality involved as would be understood by those skilled in the art.

It should be emphasized that many variations and modifications may be made to the above-described examples, the elements of which are to be understood as being among other acceptable examples. All such modifications and variations are intended to be included herein within the scope of this disclosure.

Any process descriptions, elements or blocks in the flow diagrams described herein and/or depicted in the attached figures should be understood as potentially representing modules, segments, or portions of code which include executable instructions for implementing specific logical functions or elements in the process. Alternate implementations are included within the scope of the examples described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B, and C” can include a first processor configured to carry out recitation A working in conjunction with a second processor configured to carry out recitations B and C.

It will also be appreciated that one or more of the elements depicted in the drawings/figures can also be implemented in a more separated or integrated manner, or even removed or rendered as inoperable in certain cases, as is useful in accordance with a particular application.

1. A system for protecting a battery pack during a submersion event associated with the battery pack, the system comprising:
a first sensor configured to:
detect a pressure inside the battery pack to generate a first signal indicating the pressure inside the battery pack; and
transmit the first signal to a pressure controller;
the pressure controller configured to adjust the pressure inside the battery pack within a range based on the first signal to prevent ingress of liquid into the battery pack during the submersion event.

2. The system of claim 1, wherein the pressure controller causes a valve connected to a pressure source to adjust the pressure inside the battery pack toward an upper bound of the range.

3. The system of claim 2, wherein the pressure controller causes the valve connected to the pressure source to close when the first signal indicates pressure inside the battery pack reaches the upper bound of the range.

4. The system of claim 3, wherein the upper bound is in a pressure range of 0.8 to 1 psi above a reference pressure value.

5. The system of claim 4, wherein the pressure controller causes the valve connected to the pressure source to open when the first signal indicates pressure inside the battery pack reaches a lower bound of the range.

6. The system of claim 5, wherein the lower bound is in a pressure range of 0.65 to 0.7 psi above the reference pressure value.

7. The system of claim 2, wherein the pressure source is a standalone reservoir or a part of an air suspension system of a vehicle.

8. The system of claim 1, further comprising a second sensor configured to detect the submersion event associated with the battery pack.

9. The system of claim 8, wherein responsive to detecting the submersion event associated with the battery pack, the second sensor generates a second signal to enable the pressure controller to adjust the pressure inside the battery pack within the range.

10. The system of claim 1, wherein adjusting the pressure inside the battery pack includes positively pressurizing the battery pack to result in a pressure inside the battery pack to be higher than an ambient pressure by a predetermined value or range.

11. The system of claim 10, wherein the predetermined value or range is adjustable according to a degree of submersion.

12. The system of claim 1, wherein the pressure controller is further configured to adjust the pressure inside the battery pack based on a detected ambient pressure, such that the pressure inside the battery pack is maintained at a predetermined value above the detected ambient pressure.

13. The system of claim 1, further comprising a valve that is normally closed and requires energization to open.

14. The system of claim 13, wherein the valve is configured to provide a double seal when closed.

15. The system of claim 1, further comprising pressure release valves.

16. The system of claim 15, wherein the pressure release valves are spring-loaded to prevent over-pressurization of the battery pack by releasing air when the pressure inside the battery pack exceeds a predetermined pressure threshold.

17. The system of claim 1, wherein the system is configured to perform a pack check to determine a sealing integrity of the battery pack and to flag an error if a leak is detected.

18. The system of claim 2, wherein the system includes hoses that connect the valve to an ancillary volume and an enclosure volume within the battery pack.

19. The system of claim 1, wherein the system is configured to operate within a pressure range inside the battery pack of approximately 80 kPa to 115 kPa.

20. The system of claim 1, wherein the system is configured to adjust the pressure inside the battery pack in response to environmental conditions including changes in altitude and temperature.

21. The system of claim 1, further comprising a feature for detecting thermal changes within the battery pack to determine a degree of breach a sealing of the battery pack.

22. The system of claim 21, wherein the feature for detecting thermal changes utilizes pressure changes associated with heat generation during charging of the battery pack.

23. The system of claim 1, further comprising a user interface element allowing a user to manually initiate positive pressurization of the battery pack.
